(19) United States
(12) Patent Application Publication
(10) Pub. No.: US 2026/0104995 A1
(43) Pub. Date: Apr. 16, 2026

(54) PROCESS NEAR MEMORY DEVICE, HOST AND DATA PROCESSING METHOD THEREOF

(71) Applicant: SAMSUNG ELECTRONICS CO., LTD., Suwon-si (KR)

(72) Inventors: Zongzhi Liu, Xi'an (CN); Feifei Teng, Xi'an (CN); Yanyan Guan, Xi'an (CN)

(73) Assignee: SAMSUNG ELECTRONICS CO., LTD., Suwon-si (KR)

(21) Appl. No.: 19/016,816

(22) Filed: Jan. 10, 2025

(30) Foreign Application Priority Data
Oct. 12, 2024 (CN) 202411428074.5

(51) Int. Cl. G06F 12/02

(52) U.S. Cl. CPC G06F 12/0246

(57) ABSTRACT

The present disclosure provides a process near memory device, a host and data processing methods thereof. The data processing method performed by the process near memory device includes: receiving a data processing request for an object from a host; obtaining data of the object to be processed from the host, based on the data processing request; obtaining result data of the object by processing the data of the object; transmitting a message indicating completion of data processing to the host; and transmitting the result data of the object to a storage device corresponding to the object.

### CROSS-REFERENCE TO RELATED APPLICATIONS

This application is based on and claims priority to Chinese Patent Application No. 202411428074.5, filed on Oct. 12, 2024, the disclosure of which is incorporated by reference herein in its entirety.

### BACKGROUND

### 1. Field

The present disclosure relates to data storage, and more particularly, to a Process Near Memory (PNM) device, a host and data processing methods thereof.

### 2. Description of Related Art

Ceph is an open source distributed storage system which is intended to meet requirements of a modern enterprise for block storage, file storage, and object storage. A highly extensible framework of Ceph makes it a new norm for block storage, object storage, and a data lake. In Ceph, each Object Storage Device (OSD) Daemon for object storage corresponds to one OSD node, and for each OSD node, one storage device (e.g., a Solid-State Device (SSD)) may be set as an actual storage area. In the case of object storage, since Ceph adopts a master-slave mode for read or write operations, when a Ceph-based client writes or reads data, it may only make requests to a primary OSD node corresponding to an object to operate on data of the primary OSD node corresponding to the object and other OSD nodes. However, when Ceph writes data and restores data in a erasure coding mode, it is necessary to move and store known data in a volatile memory controlled by a Central Processing Unit (CPU), to perform computation processing using the data stored in the volatile memory, and then to write computation results to a storage device corresponding to an OSD node. In a case of processing in the erasure coding mode, a large amount of data movement and context switching between the memory and the CPU is required.

### SUMMARY

Provided is a PNM device, a host, and data processing methods thereof.

According to an aspect of the disclosure, a data processing method performed by a Process Near Memory (PNM) device includes: receiving a data processing request for an object from a host; obtaining data of the object to be processed from the host, based on the data processing request; obtaining result data of the object by processing the data of the object; transmitting a message indicating completion of data processing to the host; and transmitting the result data of the object to a storage device corresponding to the object.

The PNM device may include a memory, the obtaining the data of the object may include, based on the data processing request, receiving, by the memory, the data of the object from the host, and storing, in the memory, the data of the object, and the transmitting the result data of the object may include, in response to the completion of the data processing, transmitting the result data of the object from the memory to the storage device.

The data processing request may include a data write request for the object or a data restore request for the object, initiated by an Object Storage Device (OSD) Daemon corresponding to the object, in an erasure coding mode, and the storage device corresponding to the object may be a storage device corresponding to the OSD Daemon.

The obtaining the result data of the object may include: based on the data processing request being the data write request initiated by the OSD Daemon in the erasure coding mode, obtaining the result data by encoding the data of the object, and based on the data processing request being the data restore request initiated by the OSD Daemon in the erasure coding mode, obtaining the result data by decoding the data of the object.

The data processing method may further include: writing intermediate data generated during the encoding or the decoding into the memory; and reading the intermediate data from the memory

The PNM device may be a universal flash storage (UFS) device, the host may be a UFS host, and the PNM device and the host may be connected via a UFS interface.

According to an aspect of the disclosure, a data processing method performed by a host and a Process Near Memory (PNM) device includes: transmitting a data processing request for an object by a computation proxy of the host to the PNM device; based on the PNM device receiving the data processing request, causing the PNM device to obtain data of the object to be processed from the host; obtaining result data of the object by processing the data of the object by the PNM device; transmitting a message from the PNM device to the host indicating completion of data processing; and in response to receiving, by the computation proxy, the message indicating completion of data processing from the PNM device, causing the PNM device to transmit the result data to a storage device corresponding to the object.

The PNM device may include a memory, the causing the PNM device to obtain data of the object may include, based on the PNM device receiving the data processing request, receiving, by the memory, the data of the object from the host, and storing, in the memory, the data of the object, and the transmitting the result data of the object may include transmitting the result data from the memory to the computation proxy.

The data processing request may include a data write request for the object or a data restore request for the object, initiated by the computation proxy for an Object Storage Device (OSD) Daemon corresponding to the object, in an erasure coding mode, and the storage device corresponding to the object may be a storage device corresponding to the OSD Daemon.

The obtaining the result data of the object may include: based on the data processing request being the data write request initiated by the OSD Daemon in the erasure coding mode, obtaining the result data by encoding the data of the object, and based on the data processing request being the data restore request initiated by the OSD Daemon in the erasure coding mode, obtaining the result data by decoding the data of the object.

The data processing method may further include: writing intermediate data generated during the encoding or the decoding into the memory; and reading the intermediate data from the memory

The PNM device may be a universal flash storage (UFS) device, the host may be a UFS host, and the PNM device and the host may be connected via a UFS interface.

According to an aspect of the disclosure, a data processing system includes: a host storage system comprising at least one host processor; and at least one host memory storing one or more host instructions; a storage device; and a Process Near Memory (PNM) device comprising: at least one PNM processor; and at least one PNM memory storing one or more PNM instructions, wherein the at least one host processor is configured to execute the one or more host instructions and cause the host storage system to: transmit a data processing request for an object to the PNM device, wherein the at least one PNM processor is configured to execute the one or more PNM instructions and cause the PNM device to: obtain data of the object to be processed from the host storage system based on the data processing request, obtain result data of the object by processing the data to be processed, and transmit a message to the host storage system indicating completion of data processing, and wherein the at least one host processor is configured to execute the one or more host instructions and cause the host storage system to: in response to receiving the message indicating completion of data processing from the PNM device, causing the PNM device to transmit the result data to the storage device, wherein the storage device corresponds to the object.

The at least one PNM processor may be configured to execute the one or more PNM instructions and cause the PNM device to store the data of the object in the at least one PNM memory.

The host storage system may further include a computation proxy, the data processing request may include a data write request for the object or a data restore request for the object, initiated by the computation proxy for an Object Storage Device (OSD) Daemon corresponding to the object, in an erasure coding mode, and the storage device may be a storage device corresponding to the OSD Daemon.

The at least one PNM processor may be configured to execute the one or more PNM instructions and cause the PNM device to: based on the data processing request being the data write request initiated by the OSD Daemon in the erasure coding mode, obtain the result data by encoding the data of the object, and based on the data processing request being the data restore request initiated by the OSD Daemon in the erasure coding mode, obtain the result data by decoding the data of the object.

The at least one PNM processor may be configured to execute the one or more PNM instructions and cause the PNM device to: write intermediate data generated during the encoding or the decoding into the PNM memory; and reading the intermediate data from the PNM memory.

The PNM device may be a universal flash storage (UFS) device, the host storage system may be a UFS host, and the PNM device and the host storage system may be connected via a UFS interface.

The storage device may include a memory controller and at least one non-volatile memory.

The Process Near Memory device, the host, and the data processing methods thereof according to the embodiments of the present disclosure may perform data processing and temporary storage within the PNM device, thereby avoiding a large amount of data transmission between a CPU on a host side and a main memory. In addition, by offloading computation processing including encoding and decoding from the CPU on the host side to the PNM device, CPU utilization may be reduced and computation resources may be saved. In addition, data write and data restore processing in the erasure coding mode of Ceph is simplified by using a defined function, and data processing performance of Ceph in the erasure coding mode is improved.

It should be understood that the above general descriptions and the following detailed descriptions are only illustrative and explanatory, and are not intended to limit the present disclosure.

### BRIEF DESCRIPTION OF THE DRAWINGS

The above and other aspects and features of certain embodiments of the present disclosure will be more apparent from the following description taken in conjunction with the accompanying drawings, in which:

FIGS. 1 and 2 are diagrams illustrating examples of data processing methods in the related technology;

FIG. 3 is a diagram illustrating an example of a data processing method in the related technology and an example of a data processing method according to one or more embodiments of the present disclosure;

FIG. 4 is a flowchart illustrating a data processing method according to one or

more embodiments of the present disclosure;

FIG. 5 is a diagram illustrating an example of data write processing according to one or more embodiments of the present disclosure;

FIG. 6 is a diagram illustrating an example of data restore processing according to one or more embodiments of the present disclosure;

FIGS. 7A and 7B are diagrams illustrating an example of data in data processing according to an embodiment of the present disclosure;

FIG. 8 is a flowchart illustrating an example of data write processing according to one or more embodiments of the present disclosure;

FIG. 9 is a flowchart illustrating an example of data restore processing according to one or more embodiments of the present disclosure;

FIG. 10 is a flowchart of a data processing method according to one or more embodiments of the present disclosure;

FIG. 11 is a block diagram illustrating a PNM device according to one or more embodiments of the present disclosure;

FIG. 12 is a block diagram illustrating a host according to one or more embodiments of the present disclosure;

FIG. 13 is a diagram of a system to which a storage device is applied, according to one or more embodiments of the present disclosure;

FIG. 14 is a block diagram of a host storage system according to one or more embodiments of the present disclosure;

FIG. 15 is a block diagram of a memory system according to one or more embodiments of the present disclosure; and

FIG. 16 is a diagram of a Universal Flash Storage (UFS) system according to one or more embodiments of the present disclosure.

### DETAILED DESCRIPTION OF EXAMPLE EMBODIMENTS

In some aspects, the embodiments may provide an effective solution that enables data processing of the OSD Daemon with reduced data transmission between the memory and the CPU.

In order to enable those ordinary skilled in the art to better understand the present disclosure, one or more embodiments of the present disclosure will be described in combination with the accompanying drawings.

The terms “include/including” or “comprise/comprising” used in this specification indicate the presence of stated features, integers, steps, operations, elements, components, and/or combinations thereof, but do not preclude the presence or addition of one or more other features, integers, steps, operations, elements, components, and/or combinations thereof. It should be understood that, although the terms “first”, “second”, “third”, etc. are used to describe various information, the information should not be limited by these terms. These terms are only used to distinguish one type of information from another type of information. For example, without departing from the scope of the present disclosure, first information may be referred to as second information; and similarly, second information may be referred to as first information. As used herein, the term “in response to” may be understood to mean “when”, “while”, or “if” depending on the context.

In addition, “at least one of” appearing in the present disclosure all means that there are three kinds of juxtaposition situations: “any one of”, “a combination of any number of”, and “all of”. For example, “including at least one of A and B” includes the following three juxtaposition situations: (1) including A; (2) including B; (3) including A and B. As another example, “performing at least one of steps 1 and 2”, that is, means the following three juxtaposition situations: (1) performing step 1; (2) performing step 2; (3) performing steps 1 and 2.

Unless otherwise defined, all terms (including technical and scientific terms) used herein have the same meaning as they are understood based on the disclosure of the present application and as they are commonly understood by those of ordinary skill in the art to which the present disclosure pertains, and are not to be interpreted in an idealized or overly formalistic manner. Herein, the use of the term “may” with respect to an example or embodiment (e.g., “ . . . may include”) indicates the existence of at least one example or embodiment that includes or implements such feature, and all examples are not limited to this. Unless otherwise expressly defined, terms in a singular form also include a plural form.

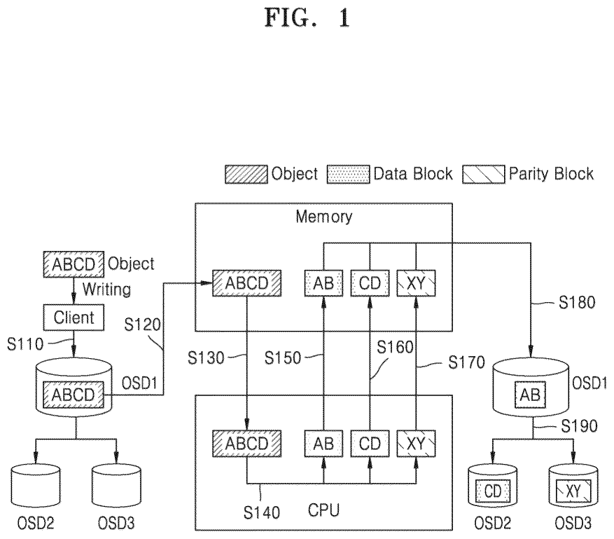

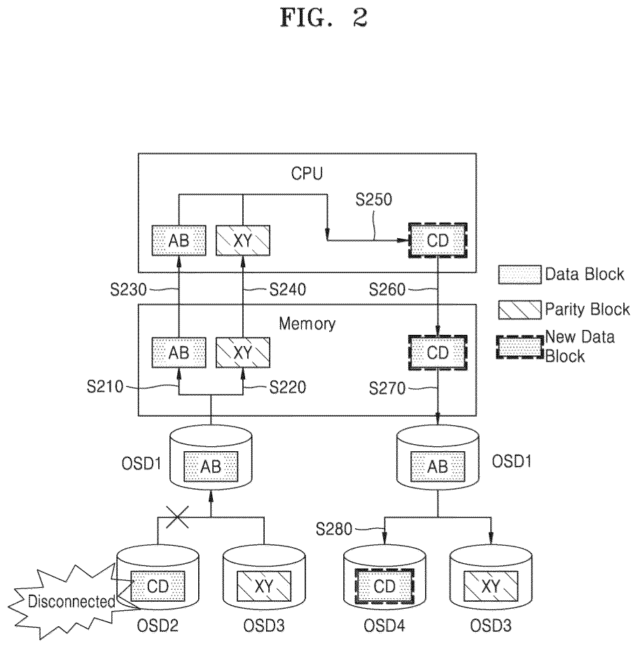

The data write processing and data restore processing in the related technology are firstly described below with reference to FIGS. 1 and 2. FIGS. 1 and 2 are diagrams illustrating examples of data processing methods of the related technology.

Referring to FIG. 1, an example of data write processing of an OSD Daemon in an erasure coding mode of the related technology is shown.

At operation S110, in response to a requirement for writing data ABCD for an object, a write request is initiated, by a client, to a primary OSD node corresponding to the object, to request to write the data for the object into a storage device OSD1 corresponding to the OSD node. In this case, in addition to OSD1 corresponding to the primary OSD node to which the data is to be written, there are storage devices such as OSD2 and OSD3 corresponding to the other OSD nodes to which the data for the object is to be written.

At operation S120, the data ABCD for the object to be written is moved from OSD1 to a memory (e.g., a volatile memory).

At operation S130, the data ABCD for the object to be written is moved from the memory to a CPU.

At operation S140, raw data AB and raw data CD in a form of a data block as well as parity data XY in a form of a parity block are computed by the CPU based on the data ABCD for the object to be written.

At operation S150, the raw data AB in the form of the data block is moved from the CPU to the memory.

At operation S160, the raw data CD in the form of the data block is moved from the CPU to the memory.

At operation S170, the parity data XY in the form of the parity block is moved from the CPU to the memory.

At operation S180, the raw data AB and the raw data CD in the form of the data block as well as the parity data XY in the form of the parity block are moved from the memory to OSD1.

At operation S190, OSD1 stores the raw data AB, and moves and stores the raw data CD and the parity data XY to OSD2 and OSD3, respectively.

Although only four data transmission operations are described in the above operations S130 to S170, in the computation processing of the CPU, the CPU must load data from the memory or temporarily store computation data to the memory by means of a plurality of read and/or write operations, which results in a large amount of data movement. In addition, a higher amount of CPU computation resources are occupied and a large number of context switches are caused.

In the erasure coding mode, when part of the raw data stored in a storage device corresponding to an OSD node is missing, the raw data may be restored by using the parity data. Referring to FIG. 2, an example of data restore processing of an OSD Daemon in the erasure coding mode of the related technology is shown.

When an OSD Daemon corresponding to OSD2 gets disconnected, the raw data CD in OSD2 is missing, in this case, a data restore request in the erasure coding mode may be initiated.

At operation S210, in response to the restore request of data for an object, the raw data AB for the object is moved from OSD1 to a memory (e.g., volatile memory).

At operation S220, parity data XY for the object for restore is moved from OSD1 to the memory. Here, the operation S220 also includes moving the parity data XY for the object for restore from OSD3 to OSD1.

At operation S230, the raw data AB for the object is moved from the memory to a CPU.

At operation S240, the parity data XY for the object is moved from the memory to the CPU.

At operation S250, new restored data CD in a form of a data block is computed by the CPU based on the raw data AB for the object and the parity data XY for the object.

At operation S260, the restored data CD in the form of the data block is moved from the CPU to the memory.

At operation S270, the restored data CD in the form of the data block is moved from the memory to OSD1.

At operation S280, the restored data CD in the form of the data block is moved and stored from the OSD1 to a new storage device OSD4.

Similarly to the data write processing, although only three data transmission operations are described in the above operations S230 to S260, in the computation processing of the CPU, the CPU must load data from the memory or temporarily store computation data to the memory by means of a plurality of read and/or write operations, which results in a large amount of data movement. In addition, a higher amount of CPU computation resources are occupied and a large number of context switches are caused.

In summary, in the related technology, a large amount of data movement and context switching leads to poor performance of write processing and restore processing, and computation processing on a large amount of data in the CPU leads to a higher CPU utilization and more energy consumption.

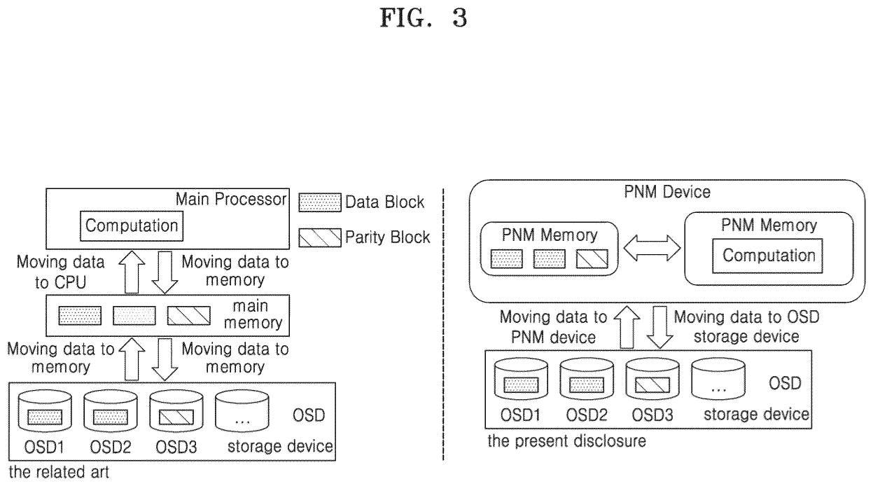

Accordingly, in order to address at least the above various problems or drawbacks, the present disclosure proposes a Process Near Memory (PNM) device, a host and data processing methods thereof, which are capable of, by using the PNM device to perform data processing instead of a CPU and a memory, reducing computation overhead of the CPU and movement of data between the CPU and the memory. Embodiments according to the present disclosure will be described in detail below with reference to FIGS. 3 to 16.

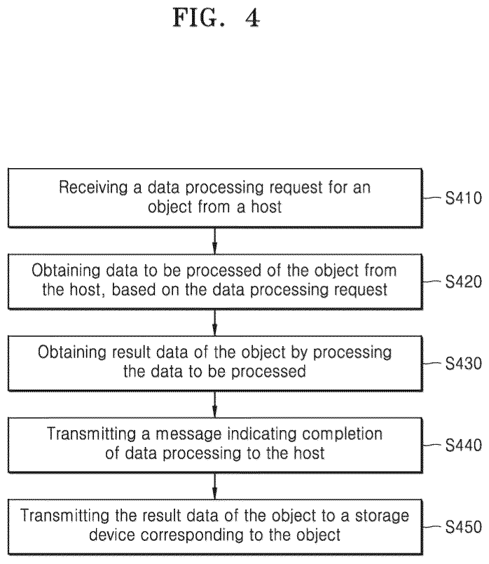

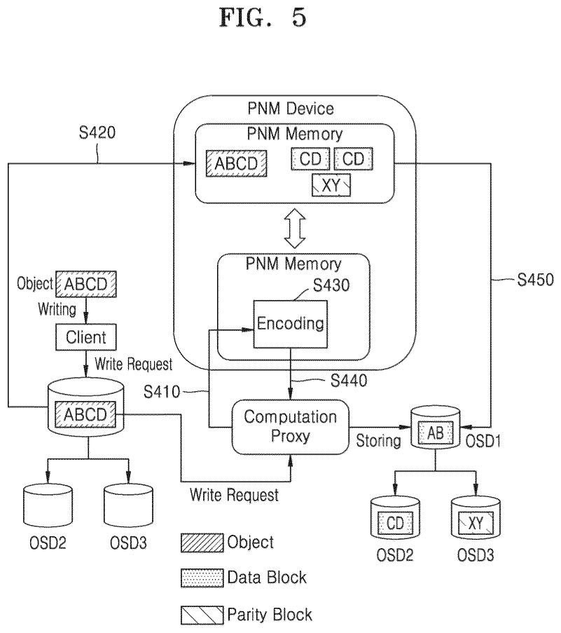

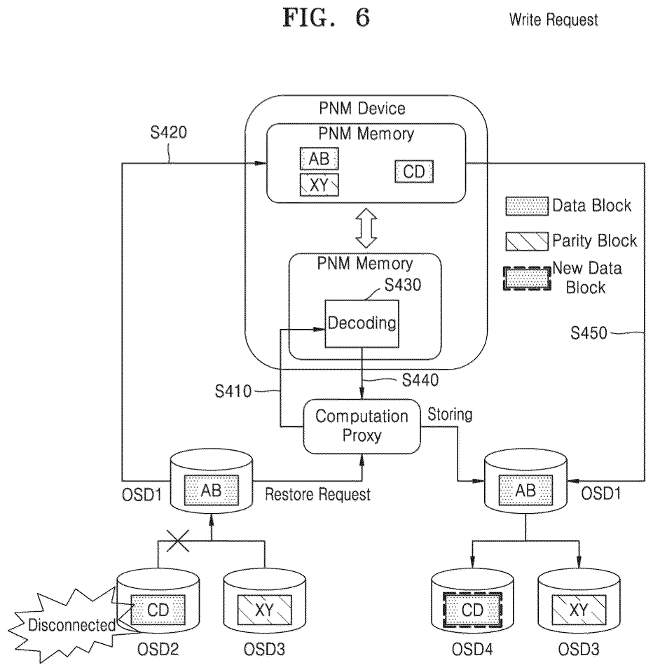

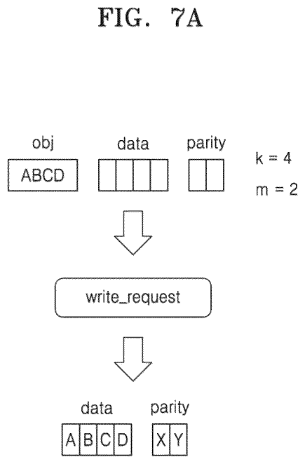

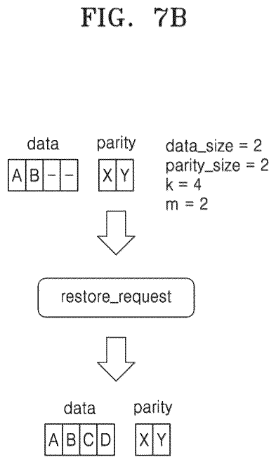

A data processing method according to an embodiment of the present disclosure is firstly described with reference to FIGS. 3 through 9. FIG. 3 is a diagram illustrating an example of a data processing method in the related technology and an example of a data processing method according to an embodiment of the present disclosure. FIG. 4 is a flowchart illustrating a data processing method according to an embodiment of the present disclosure. FIG. 5 is a diagram illustrating an example of data write processing according to an embodiment of the present disclosure. FIG. 6 is a diagram illustrating an example of data restore processing according to an embodiment of the present disclosure. FIG. 7 is a diagram illustrating an example of data in data processing according to an embodiment of the present disclosure.

In the following, in order to differentiate between modules in the host and the PNM device, a processor of the host may be referred to as a “main processor (e.g., a CPU)” or a “host processor” and a memory corresponding to the CPU on a host side may be referred to as a “main memory” or a “host memory”. Accordingly, a processor included in the PNM device may be referred to as a “PNM processor”, and a memory included in the PNM device may be referred to as a “PNM memory”. It should be understood that the terms used herein are used only for the purpose of distinguishing different elements, and are not intended to be any limitation on a functionality of the embodiments of the present disclosure, and that any other suitable term may be used to distinguish between them.

Referring to FIG. 3, in the related technology, as described above, there is a large amount of data transmission between the main processor and the main memory. However, in the present disclosure, by using a PNM device including a PNM processor and a PNM memory to implement data processing, it may be ensured that computation processing and movement of data in the computation processing occurs within the PNM device. Embodiments of the present disclosure are described in detail below in connection with FIGS. 4 through 9.

Referring to FIG. 4, at operation S410, a data processing request for an object is received from the host.

According to an embodiment, the data processing request includes a data write request or a data restore request for the object, initiated by an Object Storage Device (OSD) Daemon corresponding to the object, in an erasure coding mode. An example of data write processing corresponding to the data write request and an example of data restore processing corresponding to the data restore request will be described below with reference to FIGS. 5 and 6, respectively.

Referring to FIG. 5, in response to a write requirement for data ABCD for an object, a write request of a client is initiated, by the client, to a primary OSD node corresponding to the object to request to write the data for the object into a storage device OSD1 corresponding to the OSD node. In this case, the data processing request includes a data write request. At operation S410, a PNM device (e.g., a PNM processor included in the PNM device) receives the data write request for the data ABCD for the object, from the host.

The data write request according to the embodiment may be transmitted by calling a write_request function (or interface). For example, a declaration regarding the write_request function may be shown in Table 1 below:

TABLE 1

| Function | Declaration |
|---|---|
| write_request | int write_request(*obj, k, m, * data, *parity) |

The description of each parameter in the above Table 1 may be shown in Table 2 below:

TABLE 2

| Parameter | Parameter | |
|---|---|---|
| Type | Name | Description |
| uint64_t* | obj | an address pointer to an object |
| uint32_t | k | the number of data (blocks/bits) |
| uint32_t | m | the number of parity (blocks/bits) |
| uint64_t* | data | an address pointer to a data block, e.g. an |
| | | address pointer to raw data (vector) (output |
| | | parameter) |
| uint64_t* | parity | an address pointer to a parity block, e.g. an |
| | | address pointer to parity data (vector) (output |
| | | parameter) |

In the Table 2, the address pointer of obj may include a pointer to a location in the main memory where the data for the object of the OSD Daemon is stored before it is written, and the data pointers of data and parity may include pointers to locations in storage devices (e.g., SSDs) corresponding to OSD nodes where the data for the object of the OSD Daemon will be written.

For example, referring to FIG. 7A, parameters of a data write request according to an embodiment includes obj, data, parity, k, and m, wherein parameter values prior to the write processing of the data are null.

Referring to FIG. 6, when the OSD Daemon corresponding to the OSD2 gets disconnected, it is necessary to perform a restore processing of data for the object. In this case, the data processing request includes a data restore request. At operation S410, the PNM device (e.g., a PNM processor included in the PNM device) receives a data restore request for the data ABCD for the object, from the host (for example, a computation proxy included in the host).

The data restore request according to the embodiment may be transmitted by calling a restore_request function (or interface). For example, a declaration regarding the restore_request function may be shown in Table 3 below:

TABLE 3

| Function | Declaration |
|---|---|
| restore_request | int restore_request (*data, data_size, |
| | *parity, parity_size, k, m) |

The description of each parameter in the above Table 3 may be shown in Table 4 below:

TABLE 4

| Parameter | Parameter | |
|---|---|---|
| Type | Name | Description |
| uint64_t* | data | an address pointer to a data block, e.g. an |
| | | address pointer to raw data (vector) |
| uint32_t | data_size | size of a data block, e.g. the number of known |
| | | data (blocks/bits) in raw data (vector) |
| uint64_t* | parity | an address pointer to a parity block, e.g. an |
| | | address pointer to parity data (vector) |
| uint32_t | parity_size | size of a parity block, e.g. the number of |
| | | known data (blocks/bits) in parity data (vector) |
| uint32_t | k | the number of data (blocks/bits) |
| uint32_t | m | the number of parity (blocks/bits) |

Similarly, in the Table 4, the data pointers of data and parity may include pointers to locations in storage devices (e.g., SSDs) corresponding to OSD nodes where the data for the object of the OSD Daemon will be written.

For example, referring to FIG. 7(b), parameters of a data restore request according to an embodiment includes data, parity, data_size, parity_size, k, and m, wherein a portion of data in data is missing.

Referring to FIG. 4, at operation S420, data of the object to be processed is obtained from the host, based on the data processing request. For example, based on an address pointer (such as, obj, data, and/or parity as described above) and other parameters (such as, k, m, data_size, and/or parity_size) included in the data processing request, the data to be processed of the object is obtained from the host.

According to an embodiment, the obtaining the data of the object to be processed from the host, based on the data processing request includes: based on the data processing request, receiving and storing, by the PNM memory, the data of the object to be processed, from the host.

For example, referring to FIG. 5, when the data processing request includes the data write request, the PNM memory receives initial data ABCD to be written for the object, from the host. As another example, referring to FIG. 6, when the data processing request includes the data restore request, the PNM memory receives raw data AB and parity data XY for the object for the restoration operation, from the host.

At operation S430, result data of the object is obtained by processing the data to be processed.

According to an embodiment, the data processing may include data write processing and/or data restore processing. In addition, data processing according to the embodiment of the present disclosure may further include any other data processing that may be realized by the PNM device, and the present disclosure is not limited thereto.

According to the embodiment, the obtaining the result data of the object by processing the data to be processed includes: based on that the data processing request is the data write request initiated by the OSD daemon in the erasure coding mode, obtaining encoded data when encoding is completed, as the result data, by encoding the data to be processed. That is, when the data processing request is the data write request, the PNM device performs encoding and obtains the encoded data.

For example, referring to FIG. 5, in the erasure coding mode, the PNM device performs encoding on the data ABCD for the object, and obtains encoded data AB, CD, and XY when encoding is completed, as the result data (e.g., a data block and a parity block in FIG. 5 or output parameters data and parity in FIG. 7A). According to an embodiment, the encoding may include erasure coding encoding. According to an embodiment, a computation algorithm (such as, an erasure coding encoding and decoding algorithm) may be preset and/or built-in in the PNM device for computation processing. According to an embodiment, the encoded data AB, CD, and XY may include raw data AB and raw data CD in a form of a data block as well as parity data XY in a form of a parity block, but the data form in the present disclosure is not limited thereto.

According to an embodiment, intermediate data during the encoding is written to the PNM memory and read from the PNM memory.

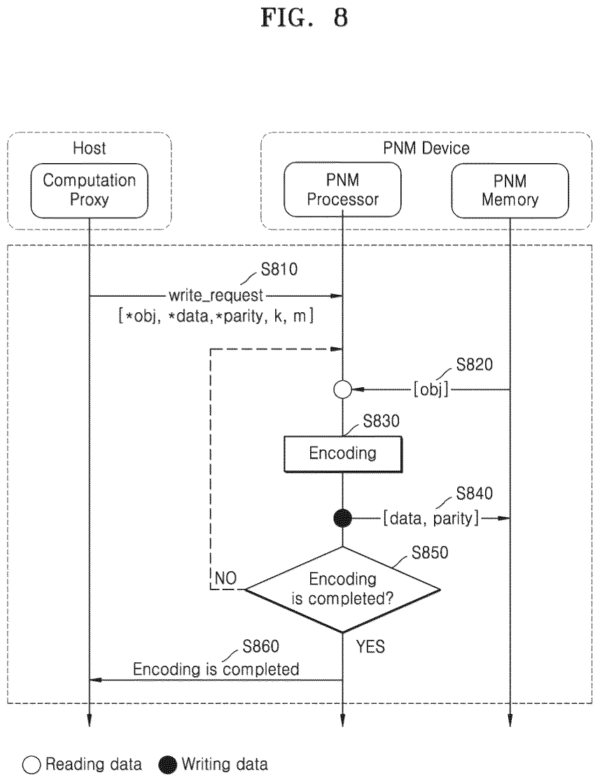

FIG. 8 is a flowchart illustrating an example of data write processing according to an embodiment of the present disclosure. Referring to FIG. 8, at operation S810, the PNM device receives a write request from a host. At operation S820, data to be encoded is received from a PNM memory. At operation S830, the data to be encoded is encoded. At operation S840, processing data obtained at operation S830 may be transmitted to and stored in the PNM memory.

At operation S850, it is determined whether the encoding is completed or not. When the encoding is completed, current encoded data may be determined as the result data and subsequent processing may be performed. When the encoding is not completed, operations S820 to S840 may be repeated until the encoding is determined to be completed. The intermediate data obtained during the repeated execution of operations S820 to S840 are transmitted and/or stored to the PNM memory for subsequent use. Such direct data transmissions between the PNM processor and the PNM memory for a large amount of processing data may greatly reduce data transmissions between the main processor and the main memory. Herein, in order to avoid obscuring the present disclosure with unnecessary details, detailed descriptions of the details in the encoding processing and a processing of the encoding completion judgment is omitted.

According to an embodiment, the obtaining the result data of the object by processing the data to be processed includes: based on the data processing request being the data restore request initiated by the OSD daemon in the erasure coding mode, obtaining decoded data when decoding is completed, as the result data, by decoding the data to be processed. That is, when the data processing request is the data restore request, the PNM device performs decoding and obtains the decoded data.

For example, referring to FIG. 6, in the erasure coding mode, the PNM device performs decoding on the raw data AB and the parity data XY for the object, and obtains the decoded data CD when decoding is completed, as the result data (such as, a new data block in FIG. 6 or output parameters data in FIG. 7B). According to an embodiment, the decoding may include erasure coding decoding. According to an embodiment, the decoded data CD may include a new restore data CD in a form of a data block, but the data form in the present disclosure is not limited thereto.

According to an embodiment, intermediate data during the decoding is written to the PNM memory and read from the PNM memory.

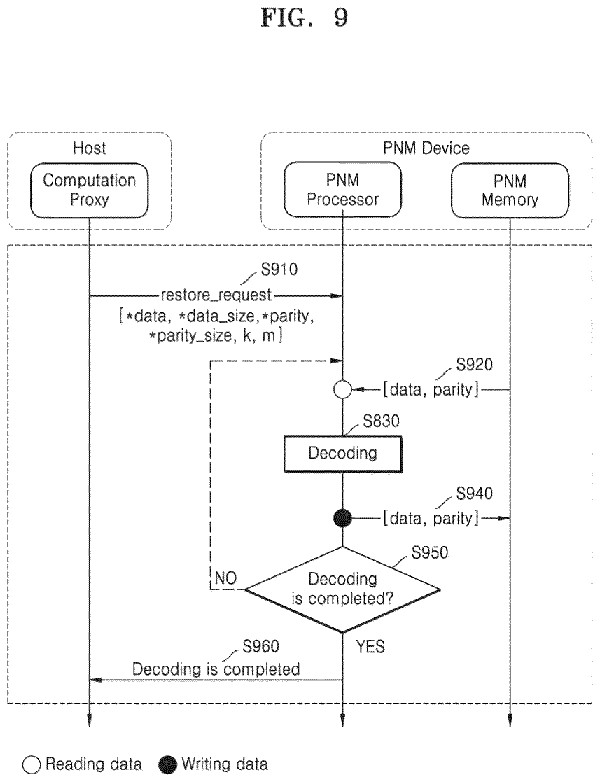

FIG. 9 is a flowchart illustrating an example of data restore processing according to an embodiment of the present disclosure. Referring to FIG. 9, at operation S910, the PNM device receives a restore request from a host. At operation S920, data to be decoded is received from the PNM memory. At operation S930, the data to be decoded is decoded. At operation S940, processing data obtained at operation S930 may be transmitted to the PNM memory and stored in the PNM memory.

At operation S950, it is determined whether the decoding is completed or not. When the decoding is completed, current decoded data may be determined as the result data and subsequent processing may be performed. When the decoding is not completed, operations S920 to S940 may be repeated until the decoding is determined to be completed. The intermediate data obtained during the repeated execution of operations S920 to S940 are transmitted and/or stored to the PNM memory for subsequent use. Such direct data transmissions between the PNM processor and the PNM memory for a large amount of processing data may greatly reduce data transmissions between the main processor and the main memory. Herein, in order to avoid obscuring the present disclosure with unnecessary details, detailed descriptions of the details in the decoding processing and a processing of the decoding completion judgment is omitted.

Returning to FIG. 4, at operation S440, a message indicating completion of data processing is transmitted to the host.

According to an embodiment, when the data processing request is the data write request, referring to FIG. 8, at operation S860, a message indicating completion of the encoding may be transmitted to the host, and when the data processing request is the data restore request, referring to FIG. 9, at operation S960, a message indicating completion of the decoding may be transmitted to the host.

At operation S450, the result data of the object is transmitted to a storage device corresponding to the object.

Wherein the transmitting the result data of the object to the storage device corresponding to the object includes: in response to the completion of the data processing, transmitting the result data of the object from the PNM memory to the storage device corresponding to the object.

According to an embodiment, the storage device corresponding to the object includes a storage device corresponding to the OSD Daemon. For example, the storage device corresponding to the object may include OSD1 corresponding to the primary OSD node as described above. According to an embodiment, the storage device corresponding to the object may include various forms of non-volatile memories (e.g., SSDs), the present disclosure is not limited thereto. For example, the resultant data of the object may be transmitted from the PNM memory to an address in the storage device indicated by address pointers of a data block and a parity block.

According to an embodiment, when the data processing request is the data write request, referring to FIG. 5, a data block and a parity block may be transmitted to OSD1, and when the data processing request is the data restore request, referring to FIG. 6, a new data block may be transmitted to OSD1. When the data is transmitted to OSD1, OSD1 may transmit or store the data to storage devices (such as, OSD2 and the OSD3) of other OSD nodes. In order to avoid obscuring the present disclosure with unnecessary details, detailed descriptions of the details on the distributed storage of the OSD is omitted herein.

The data processing method performed by a PNM according to the embodiment of the present disclosure may perform data processing and temporary storage within the PNM device, avoiding a large amount of data transmission between a CPU on a host side and a main memory. In addition, by offloading computation processing including encoding and decoding from the CPU on the host side to the PNM device, CPU utilization may be reduced and computation resources may be saved. In addition, data write and data restore processing in the erasure coding mode of Ceph is simplified by using a defined function, and data processing performance of Ceph in the erasure coding mode is improved.

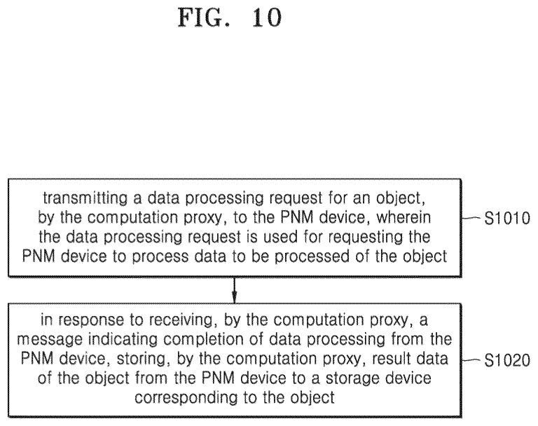

A data processing method performed by the host will be described in detail below with reference to FIG. 5 and FIG. 6 and FIGS. 8 to 10. The details of the data processing method performed by the PNM device according to the embodiment of the present disclosure described above are all applicable to the data processing method performed by the host according to the embodiment of the present disclosure. FIG. 10 is a flowchart of a data processing method according to an embodiment of the present disclosure.

In the present disclosure, a computation proxy included in a host is proposed, which may communicate with the PNM device as described above. In addition, the computation proxy may be used to control operations with respect to OSDs.

Referring to FIG. 10, at operation S1010, a data processing request for an object is transmitted by the computation proxy, to the PNM device, wherein the data processing request is used for requesting the PNM device to process data of the object to be processed.

According to an embodiment, the data processing request includes a data write request or a data restore request for the object initiated, by the computation proxy for an OSD Daemon corresponding to the object, in an erasure coding mode. The details described above with respect to the data processing request may be applicable herein. Here, although only one computation proxy is shown according to embodiments of the present disclosure, the computation proxy may be multiple, and the computation proxy may include an encoding proxy and a decoding proxy for performing encoding processing corresponding to the data write request and decoding processing corresponding to the data restore request, respectively, the present disclosure is not limited thereto.

For example, referring to FIG. 5, in response to the write request for the data ABCD for the object from a client, a computation proxy may encapsulate individual parameters as shown in Table 2 into a data write request or write them to a write_request function (or structure), and transmit the data write request to the PNM device by calling the write_request function (or structure) to initiate the data write processing. In this case, the computation proxy may also be referred to as an encoding proxy.

For example, referring to FIG. 6, in response to the restore request for the data ABCD for the object, a computation proxy may encapsulate individual parameters as shown in Table 4 into a data restore request or write them to a restore_request function (or structure), and transmit the data restore request to the PNM device by calling the restore_request function (or structure), so as to initiate data restore processing. In this case, the computation proxy may also be referred to as a decoding proxy.

Referring back to FIG. 10, at operation S1020, in response to receiving, by the computation proxy, a message indicating completion of data processing from the PNM device, the computation proxy stores result data of the object from the PNM device to a storage device corresponding to the object. According to an embodiment, the storage device corresponding to the object includes a storage device (such as, OSD1) corresponding to the OSD Daemon.

For example, referring to FIG. 8, at operation S860, the computation proxy may receive a message indicating completion of the encoding from the PNM device. For another example, referring to FIG. 9, at operation S960, the computation proxy may receive a message indicating completion of the decoding from the PNM device.

Referring to FIG. 5, after receiving the message indicating completion of the encoding, the computation proxy may control data storage at OSD1. For example, the computation proxy moves the raw data AB, the raw data CD, and the parity data XY obtained by the encoding from the PNM memory to the OSD1, and then, stores the raw data AB to the OSD1, stores the raw data CD to the OSD2, and stores the parity data XY to the OSD3.

Referring to FIG. 6, after receiving the message indicating completion of the decoding, the computation proxy may control data storage at OSD1. For example, the computation proxy moves the restored data CD obtained by the decoding from the PNM memory to the OSD1, and then, stores the restored data CD to a new storage device OSD4. According to an embodiment, when a certain OSD Daemon gets disconnected and data in the corresponding storage device is unavailable, the host determines a new OSD Daemon and the corresponding storage device (e.g., OSD4) for storing the restored data.

According to the data processing method performed by the host of the embodiment of the present disclosure, data processing and temporary storage may be performed by the external PNM device, avoiding a large amount of data transmission between a CPU on a host side and a main memory. In addition, by offloading computation processing including encoding and decoding from the CPU on the host side to the PNM device, CPU utilization may be reduced and computation resources may be saved. In addition, data write and data restore processing in the erasure coding mode of Ceph is simplified by using a defined function, and data processing performance of Ceph in the erasure coding mode is improved.

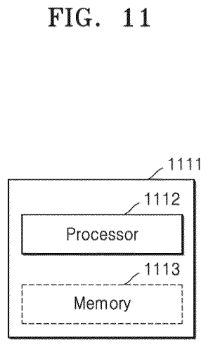

FIG. 11 is a block diagram illustrating a PNM device according to an embodiment of the present disclosure.

Referring to FIG. 11, a PNM device 1111 includes a processor 1112.

According to an embodiment, the processor 1112 is configured to: receive data processing request for an object from a host; receive data of the object to be processed from the host, based on the data processing request; obtain result data of the object by processing the data to be processed; transmit a message indicating completion of data processing to the host; and transmit the result data of the object to a storage device corresponding to the object.

That is, the processor 1112 according to the embodiment of the present disclosure may perform or control other modules (or units) of the PNM device 1111 to perform the data processing method performed by the PNM device as described above, and thus, details regarding the above data processing method may be applicable to the PNM device 1111 according to the embodiment of the present disclosure.

According to an embodiment, the PNM device may also include a memory 1113. The memory 1113 according to embodiments of the present disclosure may correspond to the PNM memory as described above, that is, operations performed by the PNM memory in the data processing method performed by the PNM device as described above may be applicable to the memory 1113.

According to an embodiment, the processor 1112 is configured to obtain the data of the object to be processed from the host, based on the data processing request, by: based on the data processing request, causing the memory 1113 to receive and store the data of the object to be processed from the host

According to an embodiment, the processor 1112 is configured to transmit the result data of the object to the storage device corresponding to the object by: in response to the completion of the data processing, transmitting the result data of the object from the memory 1113 to the storage device corresponding to the object.

According to an embodiment, the data processing request includes a data write request or a data restore request for the object, initiated by an Object Storage Device (OSD) Daemon corresponding to the object, in an erasure coding mode.

According to an embodiment, the storage device corresponding to the object includes a storage device corresponding to the OSD daemon.

According to an embodiment, the processor 1112 is configured to obtain the result data of the object by processing the data to be processed by: based on that the data processing request is the data write request initiated by the OSD daemon in the erasure coding mode, obtaining encoded data when encoding is completed, as the result data, by encoding the data to be processed, and based on that the data processing request is the data restore request initiated by the OSD daemon in the erasure coding mode, obtaining decoded data when decoding is completed, as the result data, by decoding the data to be processed.

According to an embodiment, intermediate data during the encoding or the decoding is written into and read from the memory 1113.

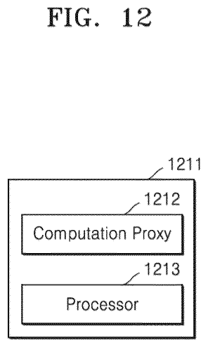

FIG. 12 is a block diagram illustrating a host according to an embodiment of the present disclosure.

Referring to FIG. 12, a host 1211 includes a computation proxy 1212 communicating with a PNM device and a processor 1213. According to an embodiment, the processor 1113 is configured to: cause the computation proxy 1212 to transmit a data processing request for an object to the PNM device, wherein the data processing request is used for requesting the PNM device to process data of the object to be processed; in response to receiving, by the computation proxy 1212, a message indicating completion of data processing from the PNM device, cause the computation proxy 1212 to store result data of the object from the PNM device to a storage device corresponding to the object. That is, the processor 1113 according to the embodiment is configured to cause the computation proxy 1212 to perform the data processing method performed by the host as described above, and thus, the details regarding the above-described data processing method may be applicable to the host 1211 according to the embodiment of the present disclosure.

According to an embodiment, the data processing request includes a data write request or a data restore request for the object initiated, by the computation proxy of an Object Storage Device (OSD) Daemon corresponding to the object, in an erasure coding mode, and wherein the storage device corresponding to the object includes a storage device corresponding to the OSD Daemon.

Further, it should be understood that individual modules or units in the PNM device 1111 and host 1211 according to the exemplary embodiments of the present disclosure may be implemented with hardware components and/or software components. Those skilled in the art may, for example, use a field programmable gate array (FPGA) or an application-specific integrated circuit (ASIC) to implement the individual modules or units, depending on the processing performed by the defined individual modules or units.

According to an embodiment of the present disclosure, there may be also provided a system to which a storage device is applied, which including: a main processor; a memory; and a storage device, wherein the main processor is configured to control the storage device to perform the data processing method performed by the PNM device as described above and/or the host processor is configured to perform the data processing method performed by the host as described above.

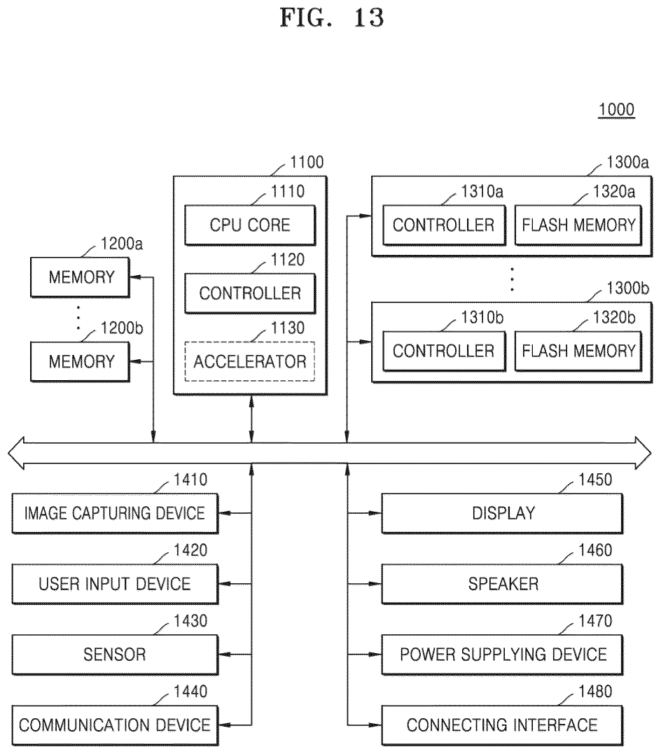

FIG. 13 is a diagram of a system 1000 to which a storage device is applied, according to an embodiment. The system 1000 of FIG. 13 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 13 is not necessarily limited to the mobile system and may be a PC, a laptop computer, a server, a media player, or an automotive device (e.g., a navigation device).

Referring to FIG. 13, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor. The main processor 1100 may be implemented as, for example, the main processor of the host as described above (e.g., the CPU of FIGS. 1 and 2, the main processor of FIG. 3) and may be configured to control the storage device to perform the data processing method performed by the PNM device as described above, and/or may be configured to perform the data processing method performed by the host as described above.

The main processor 1100 may include at least one CPU core 1110 and further include a controller 1120 configured to control the memories 1200a and 1200b and/or the storage devices 1300a and 1300b. In one or more embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100. The memories 1200a and 1200b may be implemented as, for example, the main memory of the host as described above (e.g., the memories in FIGS. 1 and 2, the main memory in FIG. 3).

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include V-NAND flash memories having a two-dimensional (2D) structure or a three-dimensional (3D) structure, the NVMs 1320a and 1320b may include other types of NVMs, such as PRAM and/or RRAM. The storage devices 1300a and 1300b may be implemented as, for example, the storage devices corresponding to the OSD daemon as described above (e.g., OSD1, OSD2, and/or OSD3 in FIGS. 1 to 6). Additionally or alternatively, the storage devices 1300a and 1300b may also be implemented as, for example, the PNM device as described above (such as, the PNM devices in FIGS. 3 through 11)), and may be configured to perform the data processing method performed by the PNM devices as described above.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The communication device 1440 may transmit and receive signals between other devices outside the system 1000 according to various communication protocols. The communication device 1440 may include an antenna, a transceiver, and/or a modem.

According to an embodiment of the present disclosure, there is also provided a host storage system comprising: a storage device, and a host, wherein the storage device is configured to perform the data processing method performed by the PNM device as described above, and/or the host is configured to perform the data processing method performed by the host as described above.

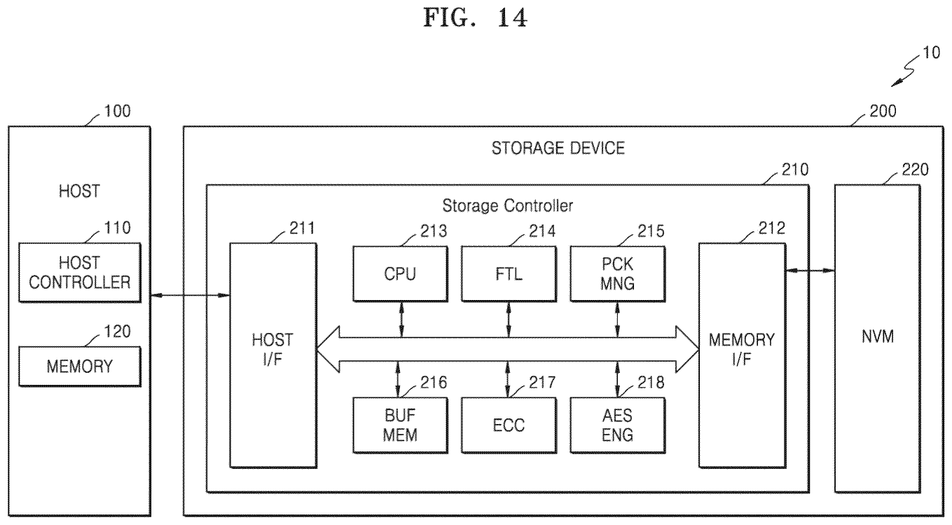

FIG. 14 is a block diagram of a host storage system 10 according to an exemplary embodiment.

The host storage system 10 may include a host 100 and a storage device 200. Further, the storage device 200 may include a storage controller 210 and an NVM 220. According to an example embodiment, the host 100 may include a host controller 110 and a host memory 120. The host memory 120 may serve as a buffer memory configured to temporarily store data to be transmitted to the storage device 200 or data received from the storage device 200. According to an embodiment, the host 100 may be implemented as, for example, the host as described above, and may be configured to perform the data processing methods performed by the host as described above. According to an embodiment, the storage device 200 may be implemented as, for example, the PNM device as described above (such as, the PNM devices of FIGS. 3 through 11)), and may be configured to perform the data processing methods performed by the PNM device as described above.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories. According to an embodiment, the NVM 220 may be implemented as, for example, the PNM memory as described above (such as, the PNM memories in FIGS. 3 to 9).

According to an embodiment, the host controller 110 and the host memory 120 may be implemented as separate semiconductor chips. Alternatively, in one or more embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region. According to an embodiment, the host controller 110 may be implemented as, for example, the computation proxy of the host as described above (such as, the computation proxy in FIGS. 5 and 6, FIGS. 8 through 10, and FIG. 12).

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory in which the FTL 214 is loaded. The CPU 213 may execute the FTL 214 to control data write and read operations on the NVM 220. According to an embodiment, the memory controller 210 may be implemented as, for example, the PNM processor as described above (such as, the PNM processor in FIGS. 3 to 9).

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to embodiments, there is also provided a storage system, which including: a memory device; and a memory controller configured to control the memory device to perform the data processing method performed by the PNM device as described above.

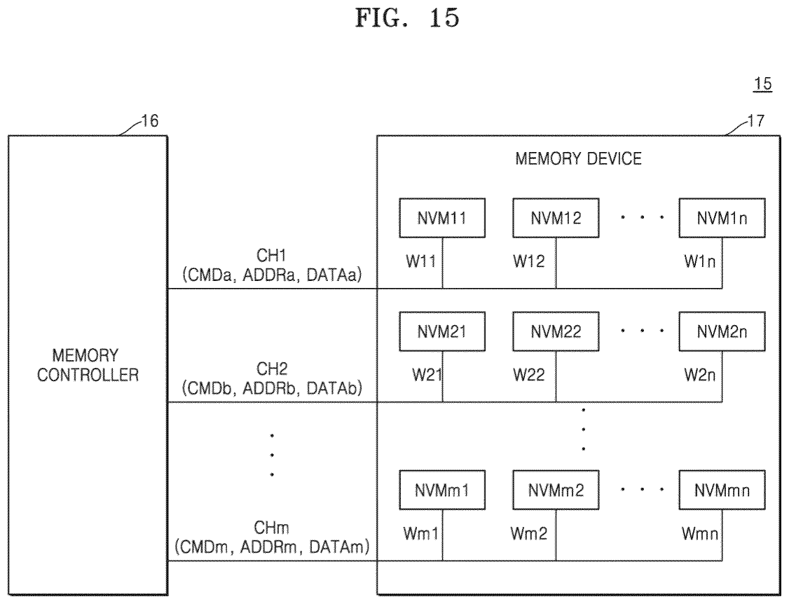

FIG. 15 is a block diagram of a memory system 15 according to an embodiment of the present disclosure. Referring to FIG. 15, the memory system 15 may include a memory device 17 and a memory controller 16. The memory system 15 may support a plurality of channels CH1 to CHm, and the memory device 17 may be connected to the memory controller 16 through the plurality of channels CH1 to CHm. For example, the memory system 15 may be implemented as a storage device, such as an SSD. According to an embodiment, the storage system 15 may be implemented as, for example, the PNM device as described above (such as, the PNM device in FIGS. 3 to 11)), and may be configured to perform the data processing method performed by the PNM device as described above.

The memory device 17 may include a plurality of NVM devices NVM11 to NVMmn. Each of the NVM devices NVM11 to NVMmn may be connected to one of the plurality of channels CH1 to CHm through a way corresponding thereto. For instance, the NVM devices NVM11 to NVM1n may be connected to a first channel CH1 through ways W11 to W1n, and the NVM devices NVM21 to NVM2n may be connected to a second channel CH2 through ways W21 to W2n. In an example embodiment, each of the NVM devices NVM11 to NVMmn may be implemented as an arbitrary memory unit that may operate according to an individual command from the memory controller 16. For example, each of the NVM devices NVM11 to NVMmn may be implemented as a chip or a die, but the present disclosure is not limited thereto. According to an embodiment, the storage device 17 may be implemented as, for example, the PNM memory as described above (such as, the PNM memories in FIGS. 3 to 9).

The memory controller 16 may transmit and receive signals to and from the memory device 17 through the plurality of channels CH1 to CHm. For example, the memory controller 16 may transmit commands CMDa to CMDm, addresses ADDRa to ADDRm, and data DATAa to DATAm to the memory device 17 through the channels CH1 to CHm or receive the data DATAa to DATAm from the memory device 17. According to an embodiment, the memory controller 16 may be implemented as, for example, the PNM processor as described above (such as, the PNM processor in FIGS. 3 to 9)), and may be configured to perform the data processing method performed by the PNM device as described above.

The memory controller 16 may select one of the NVM devices NVM11 to NVMmn, which is connected to each of the channels CH1 to CHm, by using a corresponding one of the channels CH1 to CHm, and transmit and receive signals to and from the selected NVM device. For example, the memory controller 16 may select the NVM device NVM11 from the NVM devices NVM11 to NVM1n connected to the first channel CH1. The memory controller 16 may transmit the command CMDa, the address ADDRa, and the data DATAa to the selected NVM device NVM11 through the first channel CH1 or receive the data DATAa from the selected NVM device NVM11.

The memory controller 16 may transmit and receive signals to and from the memory device 17 in parallel through different channels from each other. For example, the memory controller 16 may transmit a command CMDb to the memory device 17 through the second channel CH2 while transmitting a command CMDa to the memory device 17 through the first channel CH1. For example, the memory controller 16 may receive data DATAb from the memory device 17 through the second channel CH2 while receiving data DATAa from the memory device 17 through the first channel CH1.

The memory controller 16 may control all operations of the memory device 17. The memory controller 16 may transmit a signal to the channels CH1 to CHm and control each of the NVM devices NVM11 to NVMmn connected to the channels CH1 to CHm. For instance, the memory controller 16 may transmit the command CMDa and the address ADDRa to the first channel CH1 and control one selected from the NVM devices NVM11 to NVM1n.

Each of the NVM devices NVM11 to NVMmn may operate via the control of the memory controller 16. For example, the NVM device NVM11 may program the data DATAa based on the command CMDa, the address ADDRa, and the data DATAa provided to the first channel CH1. For example, the NVM device NVM21 may read the data DATAb based on the command CMDb and the address ADDb provided to the second channel CH2 and transmit the read data DATAb to the memory controller 16.

Although FIG. 15 illustrates an example in which the memory device 17 communicates with the memory controller 16 through m channels and includes n NVM devices corresponding to each of the channels, the number of channels and the number of NVM devices connected to one channel may be changed.

According to an embodiment, there is also provided a universal flash memory (UFS) system, which comprising: a UFS host; a UFS device; and a UFS interface that connects the UFS host with the UFS device, wherein the UFS device is configured to perform the data processing method performed by the PNM device as described above, and/or the UFS host is configured to perform the data processing method performed by the host as described above.

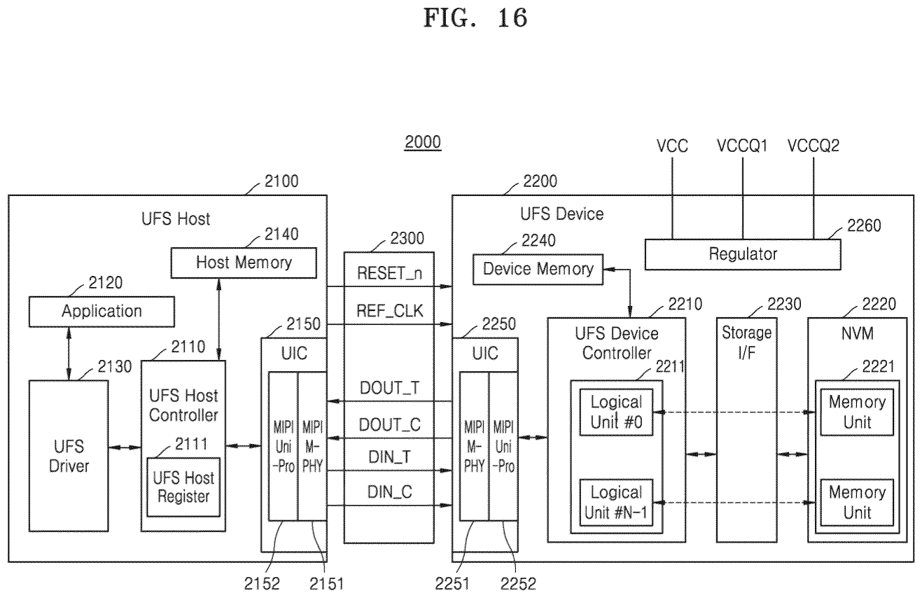

FIG. 16 is a diagram of a UFS system 2000 according to an embodiment. The UFS system 2000 may be a system conforming to a UFS standard announced by Joint Electron Device Engineering Council (JEDEC) and include a UFS host 2100, a UFS device 2200, and a UFS interface 2300. The above description of the system 1000 of FIG. 13 may also be applied to the UFS system 2000 of FIG. 16 within a range that does not conflict with the following description of FIG. 16.

Referring to FIG. 16, the UFS host 2100 may be connected to the UFS device 2200 through the UFS interface 2300. When the main processor 1100 of FIG. 13 is an AP, the UFS host 2100 may be implemented as a portion of the AP. The UFS host controller 2110 and the host memory 2140 may respectively correspond to the controller 1120 of the main processor 1100 and the memories 1200a and 1200b of FIG. 13. The UFS device 2200 may correspond to the storage device 1300a and 1300b of FIG. 13, and a UFS device controller 2210 and an NVM 2220 may respectively correspond to the storage controllers 1310a and 1310b and the NVMs 1320a and 1320b of FIG. 13. According to an embodiment, the UFS host 2100 may be implemented as, for example, the host as described above, and may be configured to control the UFS device 2200 to perform the data processing method performed by the PNM device as described above, and/or may be configured to perform the data processing method performed by the host as described above. According to embodiments, the UFS device 2200 may be implemented as, for example, the PNM device as described above (such as, the PNM device in FIGS. 3 to 11) and may be configured to perform the data processing method performed by the PNM device as described above.

The UFS host 2100 may include a UFS host controller 2110, an application 2120, a UFS driver 2130, a host memory 2140, and a UFS interconnect (UIC) layer 2150. The UFS device 2200 may include the UFS device controller 2210, the NVM 2220, a storage interface 2230, a device memory 2240, a UIC layer 2250, and a regulator 2260. The NVM 2220 may include a plurality of memory units 2221. Although each of the memory units 2221 may include a V-NAND flash memory having a 2D structure or a 3D structure, each of the memory units 2221 may include another kind of NVM, such as PRAM and/or RRAM. The UFS device controller 2210 may be connected to the NVM 2220 through the storage interface 2230. The storage interface 2230 may be configured to comply with a standard protocol, such as Toggle or ONFI.

The application 2120 may refer to a program that wants to communicate with the UFS device 2200 to use functions of the UFS device 2200. The application 2120 may transmit input-output requests (IORs) to the UFS driver 2130 for input/output (I/O) operations on the UFS device 2200. The IORs may refer to a data read request, a data storage (or write) request, and/or a data erase (or discard) request, without being limited thereto.

The UFS device controller 2210 of the UFS device 2200 may control all operations of the UFS device 2200. The UFS device controller 2210 may manage the NVM 2220 by using a logical unit (LU) 2211, which is a logical data storage unit. The number of LUs 2211 may be 8, without being limited thereto. The UFS device controller 2210 may include an FTL and convert a logical data address (e.g., a logical block address (LBA)) received from the UFS host 2100 into a physical data address (e.g., a physical block address (PBA)) by using address mapping information of the FTL. A logical block configured to store user data in the UFS system 2000 may have a size in a predetermined range. For example, a minimum size of the logical block may be set to 4 Kbyte.

When a command from the UFS host 2100 is applied through the UIC layer 2250 to the UFS device 2200, the UFS device controller 2210 may perform an operation in response to the command and transmit a completion response to the UFS host 2100 when the operation is completed.

As an example, when the UFS host 2100 intends to store user data in the UFS device 2200, the UFS host 2100 may transmit a data storage command to the UFS device 2200. When a response (a ‘ready-to-transfer’ response) indicating that the UFS host 2100 is ready to receive user data (ready-to-transfer) is received from the UFS device 2200, the UFS host 2100 may transmit user data to the UFS device 2200. The UFS device controller 2210 may temporarily store the received user data in the device memory 2240 and store the user data, which is temporarily stored in the device memory 2240, at a selected position of the NVM 2220 based on the address mapping information of the FTL.

As another example, when the UFS host 2100 intends to read the user data stored in the UFS device 2200, the UFS host 2100 may transmit a data read command to the UFS device 2200. The UFS device controller 2210, which has received the command, may read the user data from the NVM 2220 based on the data read command and temporarily store the read user data in the device memory 2240. During the read operation, the UFS device controller 2210 may detect and correct an error in the read user data by using an ECC engine embedded therein. More specifically, the ECC engine may generate parity bits for write data to be written to the NVM 2220, and the generated parity bits may be stored in the NVM 2220 along with the write data. During the reading of data from the NVM 2220, the ECC engine may correct an error in read data by using the parity bits read from the NVM 2220 along with the read data, and output error-corrected read data.

In addition, the UFS device controller 2210 may transmit user data, which is temporarily stored in the device memory 2240, to the UFS host 2100. In addition, the UFS device controller 2210 may further include an AES engine. The AES engine may perform at least of an encryption operation and a decryption operation on data transmitted to the UFS device controller 2210 by using a symmetric-key algorithm.

The UFS host 2100 may sequentially store commands, which are to be transmitted to the UFS device 2200, in the UFS host register 2111, which may serve as a common queue, and sequentially transmit the commands to the UFS device 2200. In this case, even while a previously transmitted command is still being processed by the UFS device 2200, that is, even before receiving a notification that the previously transmitted command has been processed by the UFS device 2200, the UFS host 2100 may transmit a next command, which is on standby in the CQ, to the UFS device 2200. Thus, the UFS device 2200 may also receive a next command from the UFS host 2100 during the processing of the previously transmitted command. A maximum number (or queue depth) of commands that may be stored in the CQ may be, for example, 32. Also, the CQ may be implemented as a circular queue in which a start and an end of a command line stored in a queue are indicated by a head pointer and a tail pointer.

Each of the plurality of memory units 2221 may include a memory cell array and a control circuit configured to control an operation of the memory cell array. The memory cell array may include a 2D memory cell array or a 3D memory cell array. The memory cell array may include a plurality of memory cells. Although each of the memory cells is a single-level cell (SLC) configured to store 1-bit information, each of the memory cells may be a cell configured to store information of 2 bits or more, such as a multi-level cell (MLC), a triple-level cell (TLC), and a quadruple-level cell (QLC). The 3D memory cell array may include a vertical NAND string in which at least one memory cell is vertically oriented and located on another memory cell.

According to an embodiment of the disclosure, there is also provided an electronic apparatus, which including: at least one processor; and at least one memory storing computer executable instructions. The computer executable instructions, when executed by the at least one processor, cause the at least one processor to perform the data processing method as described above.

According to the embodiment of the present disclosure, the electronic apparatus may be a PC computer, a tablet apparatus, a personal digital assistant, a smartphone, or other apparatuses capable of executing a set of instructions described above. Here, the electronic apparatus does not have to be a single electronic apparatus, but can also be any collection of apparatuses or circuits capable of executing the above instructions (or the set of instructions) individually or jointly. The electronic apparatus may also be part of an integrated control system or system manager, or a portable electronic apparatus that may be configured to be interconnected with an interface locally or remotely (e.g., via wireless transmission).

In the electronic apparatus, the processor may include a central processing unit (CPU), a graphics processing unit (GPU), a programmable logic device, a dedicated processor system, a microcontroller, or a microprocessor. By way of example and not limitation, the processor may also include an analog processor, a digital processor, a microprocessor, a multi-core processor, a processor array, a network processor, and the like.

The processor may execute instructions or code stored in memory, wherein the memory may also store data. The instructions and data may also be transmitted and received over a network via a network interface device, wherein the network interface device may utilize any known transmission protocol.

The memory may be integrated with the processor, for example, by arranging RAM or flash memory within an integrated circuit microprocessor. In addition, the memory may comprise a separate device, such as, an external disk drive, a storage array, or other storage device that may be used by any database system. The memory and the processor may be operationally coupled or may communicate with each other, for example, via I/O ports, network connections, etc., enabling the processor to read files stored in the memory.

In addition, the electronic apparatus may include a video display (e.g., a liquid crystal display) and a user interaction interface (e.g., a keyboard, a mouse, a touch input device, etc.). All components of the electronic apparatus may be connected to each other via a bus and/or network.

According to an embodiment of the present disclosure, there may be also provided a computer-readable storage medium, wherein instructions in the computer-readable storage medium, when executed by at least one processor, cause the at least one processor to perform the data processing method as described above.

According to the exemplary embodiment of the present disclosure, examples of computer-readable storage medium include: a read-only memory (ROM), a random-access programmable read-only memory (PROM), an electrically erasable programmable read-only memory (EEPROM), random-access memory (RAM), a dynamic random-access memory (DRAM), a static random-access memory (SRAM), a flash memory, a nonvolatile volatile memory, a CD-ROM, a CD-R, a CD+R, a CD-RW, a CD+RW, a DVD-ROM, a DVD-R, a DVD+R, a DVD-RW, a DVD+RW, a DVD-RAM, a BD-ROM, a BD-R, a BD-R LTH, a BD-RE, a Blu-ray or optical disk memory, a hard disk drive (HDD), a solid-state drive (SSD), a card memory (such as, a multimedia card, a Secure Digital (SD) card, or an Extreme Digital (XD) card), a magnetic tape, a floppy disk, a magneto-optical data storage device, an optical data storage device, a hard disk, a solid state disk, and any other device, the any other device is configured to store a computer program, as well as any associated data, data files, and data structures, in a non-transitory manner, and to provide the computer program and any associated data, data files and data structures to a processor or computer, to cause the processor or computer to execute the computer program. The computer program in the above computer-readable storage medium may be executed in an environment deployed in an electronic apparatus such as a client, a host, a proxy device, a server, etc. Furthermore, in one example, the computer program and any associated data, data files, and data structures are distributed across a networked computer system, such that the computer program and any associated data, data files, and data structures are stored, accessed, and executed in a distributed manner through one or more processors or computers.

The present application intends to cover any variation, use or adaptation of the present disclosure, which follow general principles of the present disclosure and include the common general knowledge or commonly-used technical means in the technical field, which are not disclosed in the present disclosure. The description and the embodiments are only regarded as exemplary, and the true scope and spirit of the present disclosure are indicated by the claims.

It should be understood that the present disclosure is not limited to the precise structure described above and shown in the drawings, and various modifications and changes may be made without departing from its scope. The scope of the present disclosure is limited only by the claims.

What is claimed is:

1. A data processing method performed by a Process Near Memory (PNM) device, the method comprising:
receiving a data processing request for an object from a host;
obtaining data of the object to be processed from the host, based on the data processing request;
obtaining result data of the object by processing the data of the object;
transmitting a message indicating completion of data processing to the host; and
transmitting the result data of the object to a storage device corresponding to the object.

2. The data processing method of claim 1,
wherein the PNM device comprises a memory,
wherein the obtaining the data of the object comprises, based on the data processing request, receiving, by the memory, the data of the object from the host, and storing, in the memory, the data of the object, and
wherein the transmitting the result data of the object comprises, in response to the completion of the data processing, transmitting the result data of the object from the memory to the storage device.

3. The data processing method of claim 1,
wherein the data processing request comprises a data write request for the object or a data restore request for the object, initiated by an Object Storage Device (OSD) Daemon corresponding to the object, in an erasure coding mode, and
wherein the storage device corresponding to the object comprises a storage device corresponding to the OSD Daemon.

4. The data processing method of claim 3,
wherein the obtaining the result data of the object comprises:
based on the data processing request being the data write request initiated by the OSD Daemon in the erasure coding mode, obtaining the result data by encoding the data of the object, and
based on the data processing request being the data restore request initiated by the OSD Daemon in the erasure coding mode, obtaining the result data by decoding the data of the object.

5. The data processing method of claim 4, further comprising:
writing intermediate data generated during the encoding or the decoding into the memory; and
reading the intermediate data from the memory.

6. The data processing method of claim 1, wherein the PNM device comprises a universal flash storage (UFS) device, the host comprises a UFS host, and the PNM device and the host are connected via a UFS interface.

7. A data processing method performed by a host and a Process Near Memory (PNM) device, wherein the data processing method comprises:
transmitting a data processing request for an object by a computation proxy of the host to the PNM device;
based on the PNM device receiving the data processing request, causing the PNM device to obtain data of the object to be processed from the host;
obtaining result data of the object by processing the data of the object by the PNM device;
transmitting a message from the PNM device to the host indicating completion of data processing; and
in response to receiving, by the computation proxy, the message indicating completion of data processing from the PNM device, causing the PNM device to transmit the result data to a storage device corresponding to the object.

8. The data processing method of claim 7,
wherein the PNM device comprises a memory,
wherein the causing the PNM device to obtain data of the object comprises, based on the PNM device receiving the data processing request, receiving, by the memory, the data of the object from the host, and storing, in the memory, the data of the object, and
wherein the transmitting the result data of the object comprises transmitting the result data from the memory to the computation proxy.

9. The data processing method of claim 7,
wherein the data processing request comprises a data write request for the object or a data restore request for the object, initiated by the computation proxy for an Object Storage Device (OSD) Daemon corresponding to the object, in an erasure coding mode, and
wherein the storage device corresponding to the object comprises a storage device corresponding to the OSD Daemon.

10. The data processing method of claim 9,
wherein the obtaining the result data of the object comprises:
based on the data processing request being the data write request initiated by the OSD Daemon in the erasure coding mode, obtaining the result data by encoding the data of the object, and
based on the data processing request being the data restore request initiated by the OSD Daemon in the erasure coding mode, obtaining the result data by decoding the data of the object.

11. The data processing method of claim 10, further comprising:
writing intermediate data generated during the encoding or the decoding into the memory; and
reading the intermediate data from the memory.

12. The data processing method of claim 7, wherein the PNM device comprises a universal flash storage (UFS) device, the host comprises a UFS host, and the PNM device and the host are connected via a UFS interface.

13. A data processing system comprising:
a host storage system comprising:
at least one host processor; and
at least one host memory storing one or more host instructions;
a storage device; and
a Process Near Memory (PNM) device comprising:
at least one PNM processor; and
at least one PNM memory storing one or more PNM instructions,
wherein the at least one host processor is configured to execute the one or more host instructions and cause the host storage system to:
transmit a data processing request for an object to the PNM device,
wherein the at least one PNM processor is configured to execute the one or more PNM instructions and cause the PNM device to:
obtain data of the object to be processed from the host storage system based on the data processing request,
obtain result data of the object by processing the data to be processed, and
transmit a message to the host storage system indicating completion of data processing, and
wherein the at least one host processor is configured to execute the one or more host instructions and cause the host storage system to:
in response to receiving the message indicating completion of data processing from the PNM device, causing the PNM device to transmit the result data to the storage device, wherein the storage device corresponds to the object.

14. The data processing system of claim 13,
wherein the at least one PNM processor is configured to execute the one or more PNM instructions and cause the PNM device to store the data of the object in the at least one PNM memory.

15. The data processing system of claim 13,
wherein the host storage system further comprises a computation proxy,
wherein the data processing request comprises a data write request for the object or a data restore request for the object, initiated by the computation proxy for an Object Storage Device (OSD) Daemon corresponding to the object, in an erasure coding mode, and
wherein the storage device comprises a storage device corresponding to the OSD Daemon.

16. The data processing system of claim 15, wherein the at least one PNM processor is configured to execute the one or more PNM instructions and cause the PNM device to:
based on the data processing request being the data write request initiated by the OSD Daemon in the erasure coding mode, obtain the result data by encoding the data of the object, and
based on the data processing request being the data restore request initiated by the OSD Daemon in the erasure coding mode, obtain the result data by decoding the data of the object.

17. The data processing system of claim 16, wherein the at least one PNM processor is configured to execute the one or more PNM instructions and cause the PNM device to:
write intermediate data generated during the encoding or the decoding into the PNM memory; and
reading the intermediate data from the PNM memory.

18. The data processing system of claim 13, wherein the PNM device comprises a universal flash storage (UFS) device, the host storage system comprises a UFS host, and the PNM device and the host storage system are connected via a UFS interface.

19. The data processing system of claim 13, wherein the storage device comprises a memory controller and at least one non-volatile memory.
